(19) United States
(12) Patent Application Publication
(10) Pub. No.: US 2003/0051145 A1
(43) Pub. Date: Mar. 13, 2003

(54) System for issuing and using secure cards

(76) Inventors: Matthew G. Jackson, Irvine, CA (US); Robert L. Hefty, Irvine, CA (US)

Correspondence Address: KLEIN, O'NEILL & SINGH, 2 PARK PLAZA, SUITE 510, IRVINE, CA, 92614, US

(21) Appl. No.: 09/949,137

(22) Filed: Sep. 7, 2001

(51) Int. Cl. H04L 9/00

(52) U.S. Cl. 713/182

(57) ABSTRACT

A software program is written in Java for multiple platform uses. The software program provides a person with a way to access a database to perform any type of transaction requiring inputting information to prevent unauthorized use thereof. A transaction card is formed on a blank card or disk and the disk is distributed to users who then enter, or are issued by administrator, unique user names and unique passwords. Encrypted personal information from the disk is then sent, in a binary string, to a remote server that contains software that places the encrypted information in a database with information with regard to the account, serial number, etc. When the disk is used at a remote retailer or other location, a reader reads the disk and a user's name and password are entered. The encrypted binary information from the disk, user's name and password are sent to the database at the remote server. The received information is compared to the information at the database and if authenticated the user is then sent to a further site to complete the transaction.

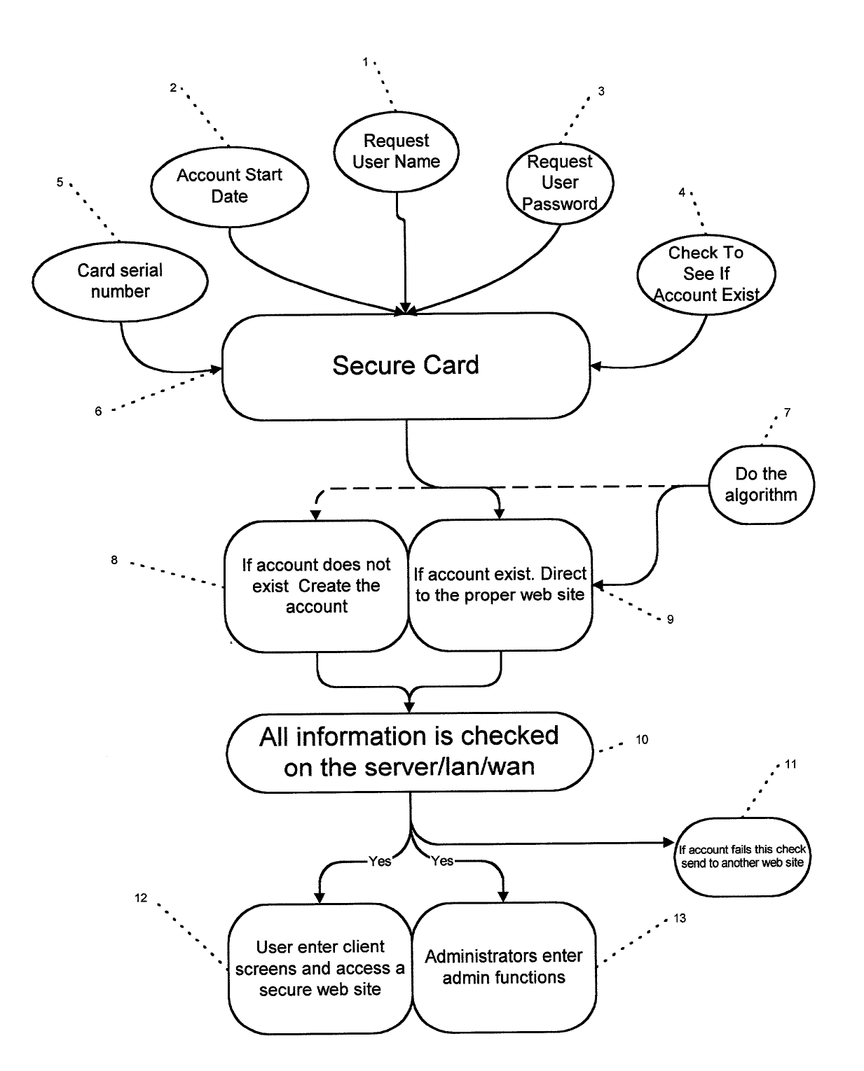

### BACKGROUND OF THE INVENTION

1. Field of the Invention

This invention relates generally to the issuance and use of data storage devices, and, in particular to a system for producing portable secure programmed data carriers such as credit cards, debit cards, identification cards, and other transaction cards having encrypted information thereon.

2. Description of Related Art

A large number of organizations issue transaction cards to be used for a number of purposes, as for example, by customers, employees, to access a database that performs a function, informing people about their health conditions, gathering information from a database, letting a person access confidential or secure information, or allowing a person to enter a secure area.

Many of such transaction cards are lost or misplaced, creating unwanted consequences and serious problems. For example, credit and debit card fraud in the U.S. alone costs the industry in excess of $1,000,000,000 annually.

Various types of encryption have been used in an attempt to prevent misuse of known transaction cards. However, many of the known encryption techniques do not work in all situations and are easily circumvented by skilled individuals. Other encryption techniques tend to be too expensive or hard to implement, and/or require special hardware not readily available, or which is too expensive for widespread use.

Accordingly, there exist a long felt need in the art to provide a secure transaction card that will be easy and safe to issue and to use, and which is both inexpensive and has broad applicability with any known platform or system. Additionally, it is necessary to provide a secure transaction card that utilizes an encrypted user name and user password to send information to a further location to enable the user to gather information from a database at the other location, and which either sends the user to a further database or place, or retrieves information from the database to enable a transaction to be performed.

### SUMMARY OF THE INVENTION

Accordingly, it is an object of the present invention to issue and use a secure transaction card that will be available to merchants, credit card companies, banks, building and sites requiring security access, identification cards, drivers licenses, and the like. It is another object of the present invention to restrict the use of an issued secure transaction card by requiring the use of an encrypted personal user name and password. It is a still further object of the present invention to provide a secure transaction card that may take the form of a CD-ROM, a DVD-ROM or a card having a magnetic stripe thereon. It is yet a further object of the present invention to provide a system that allows secure transaction cards to be issued and used in a safe and secure manner by forming an algorithm of gathered data and sending this algorithm to a separate location for processing and handling.

In carrying out this invention in one illustrated embodiment thereof, a secure program to issue secure transaction cards is disclosed as including encrypted information which issues numbers 1-9 and letters A-Z on a random basis on a card for use in a system having a first means for reading or forming cards, at one location and a separate processor having a database at a further or administrative site. The database in the processor or server at the administrative site includes software for creating encrypted information in the database. The encrypted information on the card, including a date, a selected number and a serial number is formed into an algorithm and sent over a network, in a binary string, to the administrative site. The algorithm forms the encrypted information into a binary string that is locked into the database at the administrative site. A further means is provided to allow a user to enter a personal name and password. The personal name and password are also encrypted and sent, in a binary string, to the database with the other encrypted information so as to create an encrypted new user identity. The database includes means for comparing a new encrypted user identity to existing user identities to prevent duplication. The user will be issued a secure transaction card, if no duplication exists. Thereafter, the user may use the issued card to perform a transaction at further processors on the network.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawing, which drawing is a flowchart illustrating the method employed in the present invention.

### DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide for an improved and simplified system and method of forming and using secure transaction cards, having encrypted information that is practically impossible to decode.

The secure transaction card of the present invention may be used in any situation or at a location that allows the user to enter a user name and password. The entered user name and password are then encrypted and sent in a binary string, together with other encrypted information on the card, to a processor at a separate location in, for example, any type of standard local area network or wide area network, or by a dedicated phone line, or other communication means used to connect processors. The transaction card used in the method of the present invention preferably takes the form of a CD-ROM, a DVD-ROM or a magnetic stripe type card in which information is stored on storage media.

The software program of the present invention preferably uses Java technology since the Java language has been in existence for many years and is, therefore, stable and has broad cross-platform compatability. This allows the software program and secure transaction card of the present invention to be run on practically all available systems including, but not limited to, operating systems such as Windows, Apple, Unix and Linux. Additionally, by using a Java compiler to encrypt the information in a database and on the transaction card in a binary format, such encryption is almost impossible to de-compile.

The software of the present invention is entered in a computer in a client/server network so as to allow encrypted information to be sent, in a binary string, to the separate server for storage in a database. In a preferred embodiment of the invention, encrypted information for each transaction card that is sent, in a binary string, to the server includes a user name, a user password, a date, an assigned number and a serial number that is generated for the transaction card.

The present invention allows a new user card to be formed by the information that is gathered and imported into a processor. An algorithm is formed that takes the date the account was created, gives the account an account number and also provides the account with an invisible serial number. The preferred algorithm is formed as follows: 1) Get issue date (Julian Date). 2) Get account number. 3) Get serial number. 4) Add the three numbers together, this=X. 5) If X is less than 512 convert to binary. 6) If X is more than 512 divide by 2 result=X. 7) If X contains a decimal round to nearest whole number. 8) Check if X is less than 512, if yes then convert to binary. 9) If X is greater than 512 then repeat steps 4 through 8 until X is less than 512.

The algorithm is sent, in a binary string, to a server and locked into a database on the server. The user created user name and user password are also sent to and entered into the database on the server. All the information regarding a specific transaction card, once approved and/or authorized, is encrypted and entered into the database at the server. Because of the encryption, the information on the database may only be reached by use of the transaction card that has been formed for the user.

Each time a new user transaction card is created, information in the database is checked by the server to ensure that there is no duplication. After a new user has been accepted, each time the user uses the accepted card, the user information on the card is read, the user name and password must be also entered and all are sent to the server, in a binary string, and compared to the encrypted information on the database to ensure that the card is valid. Or, the serial number may be read first and the user prompted to enter their user name and password. The user name and password, also in encrypted form are sent to the server, in a binary string, and used as a key to the address of a further computer. This address of the further computer is a check to see if the correct user name and password have been entered. After the user is redirected to the further computer they may perform a transaction. If any of the information on the card, or that entered by the user is incorrect, the user is sent somewhere else so that they may not enter the secure computer.

The system of the present invention basically has three levels of usage. One level, referred to as the first level of usage is administration or administrator. The administrator has a server that includes a database from substantially any known provider. The administrator makes sure that the database on the server is set up so as to allow for the software program of the present invention to run on the server. The administrator will also provide blank transaction cards, such as CD-ROMS, DVD-ROMS or magnetic stripe cards, compatible with the software of the present invention, for use to make new user transaction cards. Additionally, the administrator will perform auditing and other normal administrative functions with regard to user accounts set up on the server.

After a transaction card has been issued to an authorized user, the user may use the card as follows. The user will have to have access to a computer or a vendor or other site with a reader, such as a CD-drive or magnetic reader whereby the secure transaction card may be inserted and/or read. After insertion of the card into the reader, the card will be authenticated and the user will have to enter their user name and password. Once the user name and password have been sent, in a binary string, to and authenticated by the server the user may then complete a transaction with the card. For example, the card may be used in any situation such as at a retailer to purchase items, to enter an area, building or site having a secure access requirement, as an ID card, a driver's license, to access data, or any other type of situation to complete a transaction(s).

The secure transaction card of the present invention provides the following protection factors. Because the user name is encrypted immediately on input, no user name is available for anyone else to copy. Additionally, since the password is also encrypted immediately on input, it is also not available for use by an unauthorized person. Furthermore, since the destination or URL of the server, LAN or WAN computer is encrypted on the secure transaction card and not available to anyone else, a still further level of security is included. Therefore, there is no way for an unauthorized user to fraudulently interrupt, copy or otherwise duplicate or alter the flow of information from the card to the server and try to capture the data being transmitted to the server, LAN or WAN site. Again, since the site where the data is being sent needs the encrypted data from the card to even open anything thereon, there is no way for a hacker or the like to mark a site so as to come back again, without having the issued secure transaction card, user name and password.

Referring now to the drawing, the system of the present invention is shown illustrated as comprising a secure card program 6. The secure card program 6 requires that for a secure transaction card to be issued or used the following information must be available. The program enters the required information on a card in an encrypted format. To use a card or issue a card a personal user name is needed 1, also, the account start date is required at 2, and the user password at 3. After the program obtains the encrypted information, or when an authorized card is being used, the account identified thereon is checked to see if it exists at 4. A serial number is then assigned to the card when it is first made, or it is identified before the card may be used at 5. The encrypted information in the program 6, is then entered on a card, or the information already entered into the card, is then formed into an algorithm at 7 and the information is encrypted and sent, in a binary string, to a database on a remote server, LAN or WAN. The database on the server, LAN or WAN then compares the encrypted algorithm to information in the database to determine if such an account has been created. If no account exists, an account is then created at 8. If an account already exists, then the user is directed to a further processor or website at 9. As discussed all encrypted information received is checked by the server, LAN or WAN at 10. If the encrypted information received fails for any reason, such as not having a proper user name or password, or a valid account or serial number, then the user is sent to a further non-secure site 11 where no transaction may be performed using the card. If all the encrypted information is checked out and authorized by the server, LAN or WAN, then the user is sent to a separate processor, or the user may perform a transaction, such as, entering into allowed screens at a secure website at 12. The administrator will perform any required administrative functions on the server, LAN or WAN at 13.

In summary, the method of the present invention forms a secure transaction card and then allows the secure card to be used after the user enters their user name and password. All of the information is entered in to show on an input screen of a computer or the like until the user submits (hits “enter”) the data at which time it is encrypted and sent, in a binary string, to the server, LAN or WAN. The encrypted information on the card and the encrypted inputted user name and password, are sent to a remote server and compared to information in a secure database. If the information on the database is authenticated, the user is taken to a further encrypted area or location, where a transaction, such as entering a separate website, or the like, is allowed. For example, if the separate site is a web page, it will check the session ID to see if the proper identification is being used, and then a secure page on the website will load. This further check is so that the page itself cannot be bookmarked and called to without use of the card.

The encrypted information of the present invention is preferably in the Java language or some other type of binary format, this protects the source code and makes it substantially impossible to be hacked.

The present invention allows encrypted data to be transferred by an algorithm that is formed when the data is entered. This prevents the data being sent over a local area or wide area network from being stolen or hacked.

Any attempt to enter a separate site without using a card of the present invention would be futile since the card is needed to provide the user name and password and the encrypted information on the card.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A system for issuing secure transaction cards comprising:
a first computer having means for creating encrypted information on secure transaction cards including a date, a selected number, and a serial number;
means for encrypting the encrypted information on the first computer in an algorithm converted to a binary string and sending the binary string to a further computer where it is locked into a database;
means for allowing a user to create a user name and a password and entering the user name and password in an encrypted form at the first computer and sending the encrypted user name and password to the further computer so as to enter it into the database and create a new encrypted user identity;
means for comparing the new encrypted user identity to existing user identities to prevent duplication; and
issuing a secure transaction card having the encrypted user identity in a storage media thereon to the user.

2. The system of claim 1 wherein the secure transaction card is a CD-ROM.

3. The system of claim 1 wherein the secure transaction card is a DVD-ROM.

4. The system of claim 1 wherein the algorithm is converted to a binary string.

5. The system of claim 4 wherein the first computer and the second computer are in a network or an internet application.

6. The system of claim 1 wherein the algorithm is converted to a binary string having a value of X, where X is less than 512.

7. The system of claim 1 wherein the algorithm is converted to a binary string having a value of X, and where if X is greater than 512 then 512 is divided by 2 until X is a whole number less than 512.

8. The system of claim 1 wherein the algorithm is formed by adding the date, the selected number and the serial number.

9. A method of forming a secure transaction card, comprising:
entering an encrypted user name for use with the secure transaction card;
inserting an encrypted account start date on the secure transaction card;
entering an encrypted user password for use with the secure transaction card;
entering an encrypted account on the secure transaction card;
entering an encrypted serial number on the secure transaction card; and
using the encrypted information on the secure transaction card and sending it to a database in the form of a binary string to compare the binary string to information in the database.

10. The method of claim 9, including the further step of issuing a secure transaction card to a user with the encrypted information thereon, after the binary information, converted from the encryption, has been compared to information on the database to prevent duplication.

11. The method of claim 10, including the further step of allowing a user to complete authorized transactions with the issued card by inserting the issued card into a reader at a remote location.

12. A system for using secure transaction cards comprising:
an administrative database at a first location on a network or internet;
a user having a secure transaction card with encrypted information on a storage media thereon;
a second remote location on the network having a reader for reading the secure transaction card;
a means for the user to enter an encrypted user name and an encrypted password at the second remote location;
means for sending the encrypted user name, encrypted password and the encrypted information on the secure transaction card over the network or internet, in a binary string, to the administrative database; and
means to send approved encrypted information from the administrative database to a further remote location on the network to enable a user to complete a transaction.

13. The system of claim 12 wherein upon approval of the encrypted information the user is sent to a secure website on the network or internet.
